(19) United States
(12) Patent Application Publication
(10) Pub. No.: US 2010/0195469 A1
(43) Pub. Date: Aug. 5, 2010

(54) Media Pre-Write With Track-Aligned Write Beam Deflection and Write Frequency Adjustment

(75) Inventor: Douglas M. Carson, Cushing, OK (US)

Correspondence Address: FELLERS, SNIDER, BLANKENSHIP, BAILEY & TIPPENS, PC, 100 NORTH BROADWAY, SUITE 1700, OKLAHOMA CITY, OK, 73102-8820, US

(73) Assignee: DOUG CARSON & ASSOCIATES, INC., Cushing, OK (US)

(21) Appl. No.: 12/698,892

(22) Filed: Feb. 2, 2010

Related U.S. Application Data
(60) Provisional application No. 61/149,106, filed on Feb. 2, 2009.

(51) Int. Cl. G11B 7/00

(52) U.S. Cl. 369/100; G9B/7

(57) ABSTRACT

Method and apparatus for formatting a data storage medium, such as a magnetic or optical disc. In accordance with various embodiments, a data storage medium is rotated while a write beam is used to write data to the rotating medium. The data are written in the form of a plurality of concentric data tracks. A deflection angle of the write beam is continuously adjusted in an axial direction along each track. In some embodiments, the axial deflection of the write beam imparts a desired angular offset between a beginning point of a first track and a beginning point of an immediately adjacent second track. This allows a first translation geometry, such as a linear translation path of a linear actuator, to emulate a different second translation geometry, such as a rotary translation path of a rotary actuator.

### RELATED APPLICATION

The present application makes a claim of domestic priority to U.S. Provisional Patent Application 61/149,106 filed Feb. 2, 2009, which is hereby incorporated by reference.

### BACKGROUND

Data storage media are used to store and retrieve large amounts of digitally encoded data in a fast and efficient manner. Such media have been commercially provided in a number of different forms, such as magnetic, optical, solid-state (e.g., flash memory), etc.

Some media, such as magnetic and optical discs, can be rotated at a selected velocity while a head assembly transduces a read back signal to recover a data pattern stored to a media surface. The data patterns are often arranged on such media along a series of concentric tracks (e.g., discrete rings, a continuous spiral, etc.). An actuator, under the control of a closed loop servo circuit, can be used to position the head assembly adjacent the tracks in order to recover the data patterns.

Actuators can be rotary in nature so as to pivot about a pivot point adjacent an outermost diameter (OD) of a medium. In this way, the head assembly follows a curvilinear translation path across the radius of the medium. By contrast, linear actuators advance and retract the head assembly along a linear translation path across the radius of the medium.

In some cases, data patterns can be pre-written to a medium during manufacture to provide servo or other types of control information. The pre-written patterns may be written using an actuator with a different translation path geometry than that of a reader system used to subsequently access the medium. In such cases, the pre-written data may not conform to the finally utilized translation geometry of the reader system. This may lead to offsets (e.g., relative differences in angular position of the head assembly with respect to the data) as the head moves from one track to the next.

### SUMMARY

Various embodiments of the present invention are generally directed to a method and apparatus for formatting a data storage medium, such as a magnetic or optical disc.

In accordance with various embodiments, a data storage medium is rotated while a write beam is used to write data to the rotating medium. The data are written in the form of a plurality of concentric data tracks. A deflection angle of the write beam is continuously adjusted in an axial direction along each track.

In some embodiments, the axial deflection of the write beam imparts a desired angular offset between a beginning point of a first track and a beginning point of an immediately adjacent second track. This allows a first translation geometry, such as a linear translation path of a linear actuator, to emulate a different second translation geometry, such as a rotary translation path of a rotary actuator.

These and other features and advantages of the various embodiments of the present invention can be understood from a review of the following detailed description in conjunction with the accompanying drawings.

### BRIEF DESCRIPTION OF THE DRAWINGS

FIG. 1 shows a reader system which accesses a data storage medium along a rotary translation path.

FIG. 2 is a writer system which advances a write element to write data to the medium of FIG. 1 along a linear translation path.

FIG. 3 shows an electron beam recorder (EBR) operated in accordance with various embodiments.

FIG. 4 shows a number of adjacent tracks on a medium with associated beginning/end points corresponding to a rotary translation path as in FIG. 1.

FIG. 5 illustrates application of X axis deflection during the writing of data by the EBR of FIG. 3.

FIGS. 6A-6D illustrate the application of Y axis deflection and write frequency adjustments during the writing of data by the EBR of FIG. 3.

FIG. 7 illustrates negative and positive Y direction offsets during the writing of concentric tracks to a storage medium.

FIG. 8 shows changes in Y direction offsets with respect to radius.

FIG. 9 is a flow chart for a DATA PRE-WRITE routine.

FIGS. 10A-10B illustrate writing of data using a positive displacement Y offset in accordance with various embodiments.

FIGS. 11A-11B show writing of data using a negative displacement Y offset in accordance with various embodiments.

### DETAILED DESCRIPTION

Various embodiments of the present invention are generally directed to a method and apparatus for formatting a storage medium, such as a magnetic or optical storage disc. Data patterns are pre-written to the medium using an actuator of a writer system that moves a first head assembly along a first translation path across a radius of the medium. The first translation path is different from a second translation path used by a reader system to move a second head assembly across the medium (or a replica thereof).

Generally, the data are pre-written by the writer system using a track-aligned write beam deflection and an adjusted write frequency to compensate for differences in the respective geometries of the first and second translation paths. In this way, the pre-written data patterns are arranged to match the geometry of the second translation path.

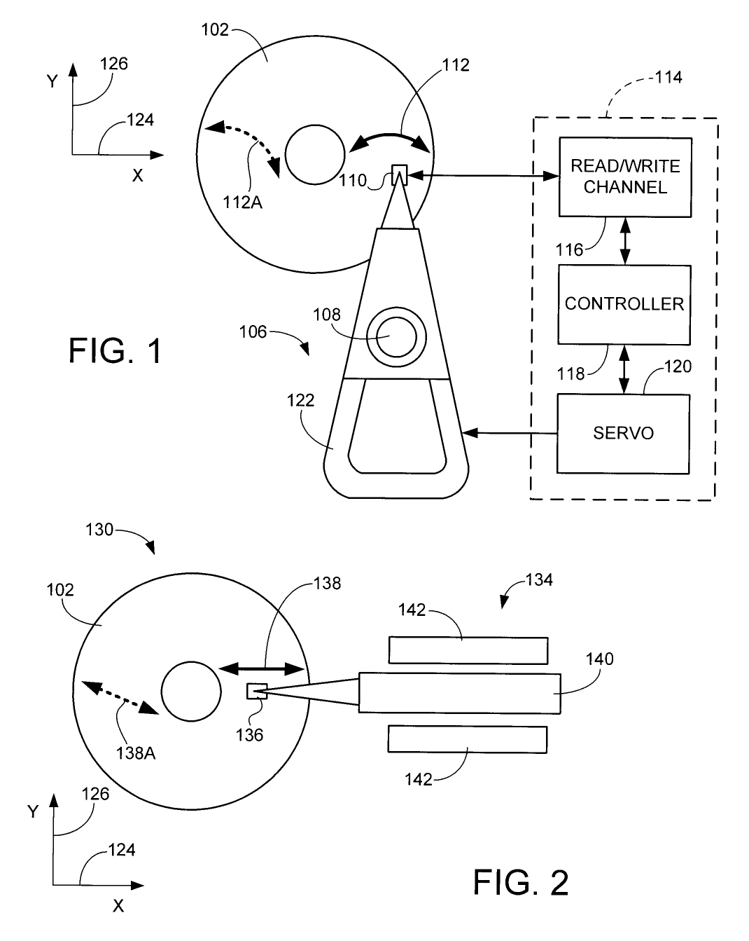

To illustrate these and various other features of presently preferred embodiments, FIG. 1 shows a schematic depiction of a reader system 100. The reader system includes a storage medium 102, such as a magnetic storage disc, which is rotated by a motor 104 at a selected velocity. In some embodiments, the motor 104 rotates the medium 102 at a constant velocity (constant angular velocity, or CAV).

A rotary actuator 106 is positioned adjacent an outermost diameter (OD) of the medium 102. The actuator 106 pivots about a pivot shaft 108, thereby moving a head assembly 110 along a curvilinear translation path, as generally denoted at 112. It is contemplated that the head assembly 110 can carry out both read and write operations with the medium 102, although such is not necessarily required.

Reader system electronics are generally denoted at 114, and include a read/write (R/W) channel 116, a controller 118, and a servo circuit 120. The read/write channel 116 handles data exchanges with the head assembly 110 to transfer data between the medium 102 and a host device (not shown). The controller 118 provides top level control of the system 100. The servo circuit 120 provides a closed-loop servo control operation to position the head assembly 110 adjacent various tracks (not shown) defined on the medium surface. In some embodiments, the servo circuit 120 applies controlled current to a coil 122 of a voice coil motor (VCM, not fully shown) to pivot the actuator 106 about the pivot shaft 108.

X and Y axial directions are defined at 124 and 126. The X direction corresponds to a radial direction across the medium 102, from a center axis to the OD. The Y direction corresponds to a tangential direction along each track on the medium 102. It will be noted that the curvilinear translation path 112 has both X and Y components. The X component portion of the path 112 is constant with respect to disc radius, and the Y component portion of the path 112 varies with disc radius. Other curvilinear translation paths can be used that have both X and Y component portions that vary with disc radius, such as illustrated by alternative path 112A.

FIG. 2 provides a schematic representation of portions of a writer system 130. The writer system 130 is configured to pre-write data patterns to the medium 102 of FIG. 1. While not limiting, it is contemplated that in some embodiments the pre-written data patterns can include embedded servo data used by the servo circuit 120 during seeking and track following operations of the reader system 100. In some embodiments, the medium written by the writer system 130 is a master disc from which a population of replicated discs (replicas) are produced, such as via a printing or stamping operation.

The writer system 130 includes a motor 132 which rotates the medium 102 at a selected velocity. This velocity may or may not match that of the velocity imparted by the motor 104 of the reader system 100 (see FIG. 1). The motor 132 in FIG. 2 may rotate the medium 132 using a constant linear velocity (CLV), or some other profile.

A linear actuator 134 is provided adjacent the medium 102, and is used to advance and retract a write head assembly 136 along a linear translation path 138 across the radius of the medium 102. Such lateral movement can be achieved by the selective application of current to a coil 140, which interacts with a magnetic field provided by permanent magnets 142. It will be noted that the linear translation path 138 is aligned along the X direction 124 and has substantially no Y directional component. Alternative linear paths are envisioned, such as path 138A with both X and Y linear components.

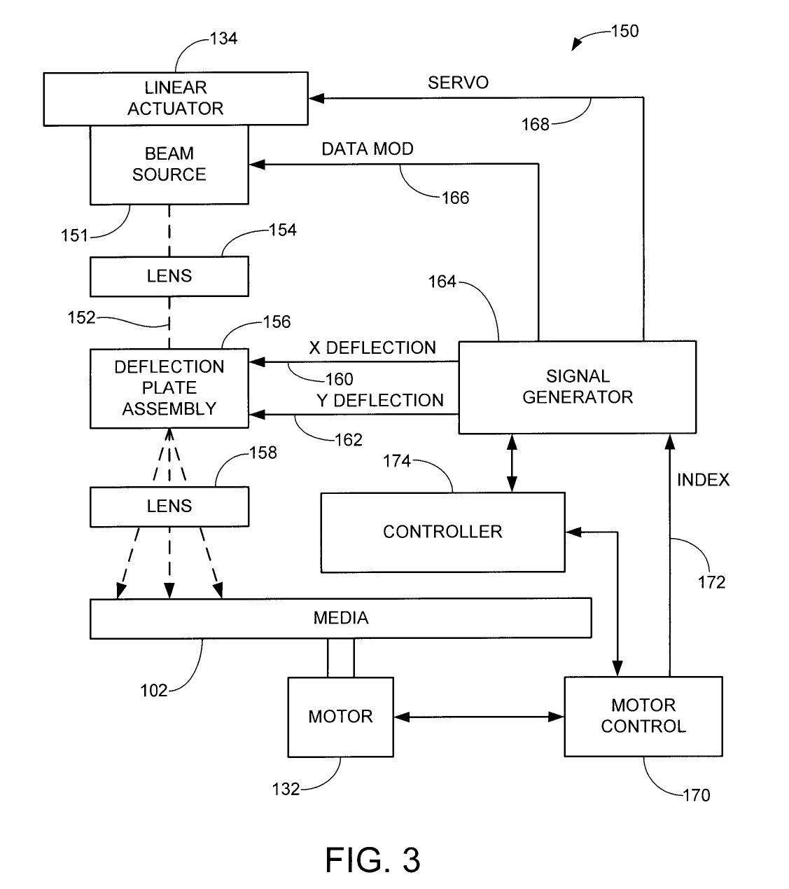

In some embodiments, the head assembly 136 of FIG. 2 is characterized as a head assembly of an electron beam recorder (EBR) 150 shown in FIG. 3. An EBR operates to generate a write beam comprising a stream of electrons. The write beam impinges the associated medium to write a pattern thereto. The interaction of the beam with the medium may be magnetic, chemical, dye reactive, etc. Other types of write beams are contemplated, so the EBR 150 in FIG. 3 is merely illustrative and not limiting.

A beam source 151 generates a write beam 152. The write beam 152 is passed through an upper lens assembly 154, adjacent a deflection plate assembly 156, and through a lower lens assembly 158 to impinge upon the medium 102. The deflection plate assembly 156 imparts controlled deflection of the beam 152 along the respective X and Y directions.

The deflection plate assembly 156 can be arranged as respective pairs of parallel plates disposed on opposing sides of the beam path. The application of controlled voltage signals, as indicated by the X deflection and Y deflection signals on paths 160 and 162, impart a controlled displacement of the axial path of the write beam 156. A closed loop detection mechanism can be employed to ensure the desired amount of beam deflection is obtained in response to a given desired input.

The X and Y deflection signals are generated by a signal generator block 164. The block 164 also generates a data modulation signal which is provided on path 166 to the beam source 151 to modulate (turn on/off) the write beam 152. The signal generator 164 further provides servo control signals on path 168 to the linear actuator 134 to advance the head assembly 136 across the medium along path 138 (see FIG. 2).

Control of the motor 134 is provided by a motor control circuit 170. In some embodiments, the motor control circuit 170 can provide a once-per-revolution index signal to the signal generator, as indicated by path 172. A controller 174 provides top level control of the EBR 150.

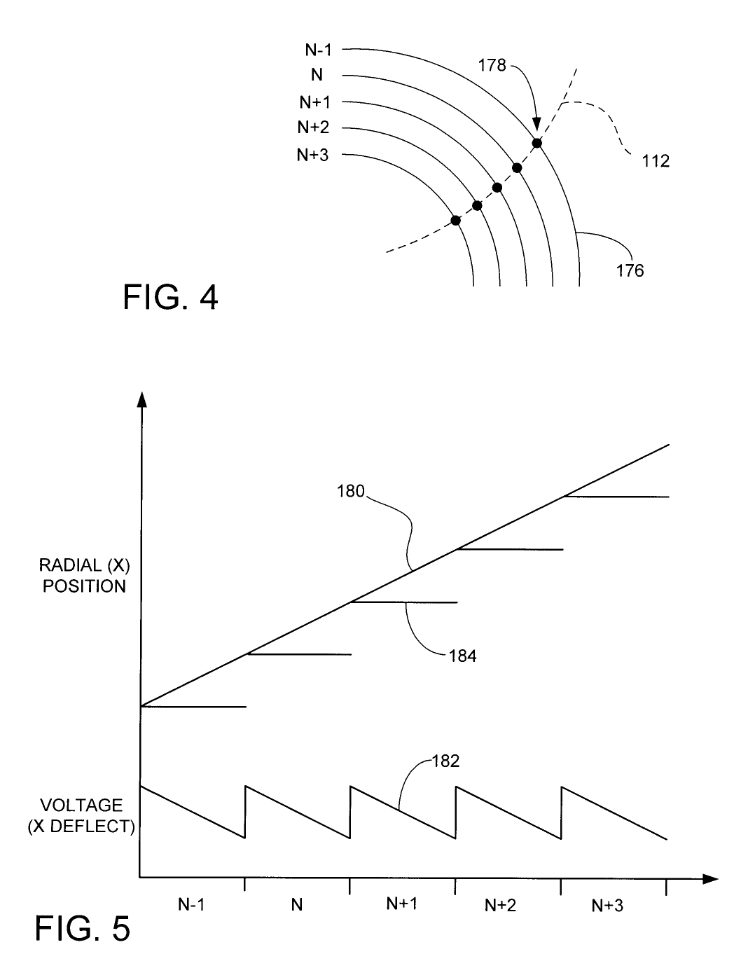

FIG. 4 is an exaggerated view of a number of adjacent tracks 176 on the medium 102. The tracks are arbitrarily denoted as N−1 to N+3. A portion of the curvilinear translation path 112 of the reader system actuator 106 (see FIG. 1) is also shown in exaggerated form in FIG. 4. A series of points 178 are shown for each track, corresponding to the intersection points along each of the tracks N−1 to N+3 over which the reader head assembly 110 (FIG. 1) will pass when the medium is at a selected angular location.

From FIG. 4 it can be seen that an angular offset can exist from one track 176 to the next for a given angular position of the medium 102, due to the Y component of the pivot translation path 112. For example, assume that the angular position of the medium in FIG. 4 corresponds to the medium being aligned exactly with a given once-per-rev index point.

Further assume that the tracks are written using so-called zone based recording (ZBR) or zoned constant angular velocity (ZCAV) recording techniques. Using ZCAV (ZBR) means that each of the tracks N−1 to N+3 has exactly the same number of channel bits recorded thereto. This will provide each of the tracks in a given zone with the same number of data sectors, allowing the read/write channel to select and maintain a given read/write frequency for data exchanges with tracks in the given zone.

It follows that if the pre-written data on the medium 102 are arranged so that the starting bit for each track is angularly aligned (e.g., follows a straight path in the X direction), then depending on the direction of medium rotation, the intersection point 178 on track N will be either logically ahead of, or behind, the point 178 on track N−1. Similar offsets will similarly be provided for other adjacent tracks.

Thus, if the read head assembly 110 (FIG. 1) reads the entirety of track N−1 and then immediately undergoes a one-track displacement to place the head assembly 110 on the adjacent track N, a track-to-track timing offset will occur; either the starting bits on track N−1 will have already passed the head assembly 110, requiring a one-revolution latency for these data bits to rotate around to the head, or the starting bits on track N will lag the corresponding bits already obtained from track N−1, so the index point will once again be passed. Either way, such offsets can disrupt the efficient transfer of data between the medium and the channel.

Accordingly, various embodiments of the present invention operate to use a writer system such as 130 in FIG. 2 to pre-write data to a medium in such a way as to match the translation geometry of a reader system such as 100 in FIG. 1. While the various embodiments disclosed herein provide the exemplary writer system with a linear actuator and the exemplary reader system with a rotary actuator, such is merely illustrative and is not limiting.

It is contemplated that both systems might employ the same kind of actuator, as in the case where the writer system has a first curvilinear translation path and the reader has a second curvilinear translation path. The writer system might provide rotary actuation and the reader system might provide linear actuation. The writer system might provide linear actuation at a selected offset angle across the radius of the medium, and the reader may provide linear actuation at a second angle (including zero degrees of offset) across the medium.

The respective systems might nominally follow the same path, but differences in translation geometry may nevertheless occur for other reasons, such as differences in head assembly construction or operation, electrical or mechanical offsets in the respective systems, etc. Thus, it will be appreciated that the various embodiments have wide applicability to a variety of different applications.

X deflection profiling of the write beam in accordance with various embodiments first be discussed, with reference to FIG. 5. It will be appreciated that such X deflection is preferred, but not necessarily required.

As shown in FIG. 5, an X direction write head translation curve is shown at 180. The curve 180 is substantially linear, indicative of a constant velocity being imparted to the write head assembly 136 (e.g., beam source 151, lens assemblies 154, 158 and deflection plate assemblies 156) during the pre-write operation. Because of the mass and associated inertia of the head assembly, moving the assembly along a continuous profile, such as at a constant velocity, advantageously reduces the excitation of resonances which might affect the ultimate impingement location of the beam 152 onto the medium 102. Such characteristic resonances can be excited even if the beam source is maintained in a stationary relation and other aspects of the system, such as lenses, mirrors, etc. are moved to radially advance the write beam across the medium.

Constant movement of the write head assembly further increases the efficiency of the write operation. The use of stepwise, incremental advances of the head assembly might undesirably lengthen the pre-write operation. This is due to the requisite time to advance and settle the head assembly at each new radius, as well as the rotational latency delay required for the appropriate angular location of the medium to rotate around to the head assembly.

While a linear radial velocity is shown by 180, other profiles can alternatively be used. While not shown in FIG. 3, a closed loop detection and control system, such as a laser inferometer, can be used to ensure precise movement of the actuator along the profile 180.

As the head assembly 136 is continually swept across the medium 102 (in this case, from the OD to the ID), a generally saw-tooth voltage profile 182 is applied with transitions coincident with each track boundary. This profile 182 in FIG. 5 corresponds to the X deflection signal on path 160 in FIG. 3. It will be appreciated that the relative change and polarity of the voltage profile 182 will be adapted for a given application.

The voltage profile 182 will generally cause the write beam 152 to stay “on-track” as the write head assembly 136 continues to move in the selected radial direction. This results in the sequential writing of data patterns to each track, as represented at 184. At the conclusion of the writing of the last bit of a given track, the write beam “snaps” back in sufficient time to write the first bit for the next track.

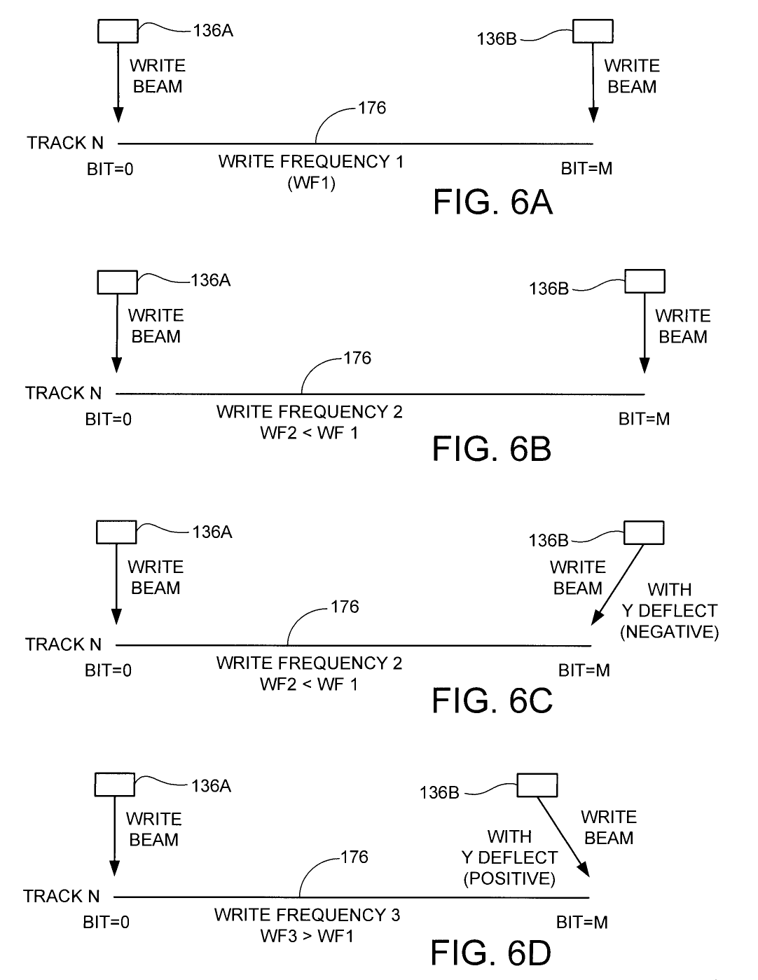

Y directional deflection control in accordance with various embodiments is discussed in FIGS. 6A-6D. It will be recalled that the Y direction is aligned with and extends along the length of each track. A conventional write operation to a selected track N is initially shown in FIG. 6A. It is contemplated that the writing operation places M+1 total channel bits onto the track (from bit 0 to bit M). These bits are written at a first selected write frequency (WF1).

No Y direction deflection is applied to the write beam 152 during the writing of the M+1 bits to the track N in FIG. 6A. The initial orientation of the head assembly and write beam at the beginning of the track (bit 0) is denoted at 136A, and the final orientation of the head assembly and write beam at the end of the track (bit M) is denoted at 136B. Thus, as the track is written, no change in the angle of the write beam 152 along the Y direction is provided.

It will be recognized that while the track N is represented in FIG. 6A as a straight line, the path along the associated medium 102 will actually be a closed circle. Thus, if the head is maintained on track, at the completion of one more clock period the medium will have completed an entire “lap” and will be commencing a second rotation, at which point the relative position of the head with respect to the medium will correspond to the position 136A.

FIG. 6B shows a similar pre-write operation to that of FIG. 6A, except that a second, reduced write frequency (WF2) is employed. Because the medium is rotated at the same angular velocity in both FIGS. 6A and 6B, the slightly lower write frequency WF2 will result in a uniform lengthening of each of the bits written to the track N. Thus, the linear length of track N as represented in FIG. 6B constitutes a full rotation of the medium, plus a portion of a second rotation. Thus, some of the initial bits written initially to the track will have been overwritten to the extent that the linear length in FIG. 6B is longer than that of FIG. 6A.

FIGS. 6A and 6B can now be used to understand the implementation of Y directional offsets during the writing of data in accordance with preferred embodiments, as set forth by FIGS. 6C and 6D. In FIG. 6C, the second, lower frequency WF2 from FIG. 6B is applied during the writing of the data pattern to the track N. However, a negative deflection offset is continuously applied in the Y direction, so that the angle of the write beam 152 gradually changes from the substantially perpendicular orientation at bit 0 to a final negative angular deflection at bit M.

The linear length of the data pattern in FIG. 6C exactly matches that of FIG. 6A, so the data patterns in FIG. 6C exactly match those of FIG. 6A. However, the head assembly at position 1368 in FIG. 6C is advanced in a positive Y direction as compared to the position 136B in FIG. 6A. This Y directional offset is preferably arranged such that, for the next bit to be written to the next adjacent track (e.g., track N+1), the head assembly 136 is positioned to facilitate a “snap back” of the write beam 152 to write the first bit of the next track at the desired angular location on the medium.

FIG. 6D shows an alternative writing of the data to the track N using positive deflection offset of the write beam 152. A third, higher write frequency (WF3) is selected and applied during the writing of the bits to the track. Without Y deflection of the beam, this would result in the pattern of bits not making a full circumference around the medium. However, a continuously increasing amount of Y deflection is imparted to the beam 152, as shown, thereby ensuring that the location of the bit M is in the same exact angular location as in FIGS. 6A and 6C. In this way, as before the head assembly 136 is positioned at the completion of the writing of the bit M to track N to enable a snap back of the write beam 152 to write the first bit of the next track N+1.

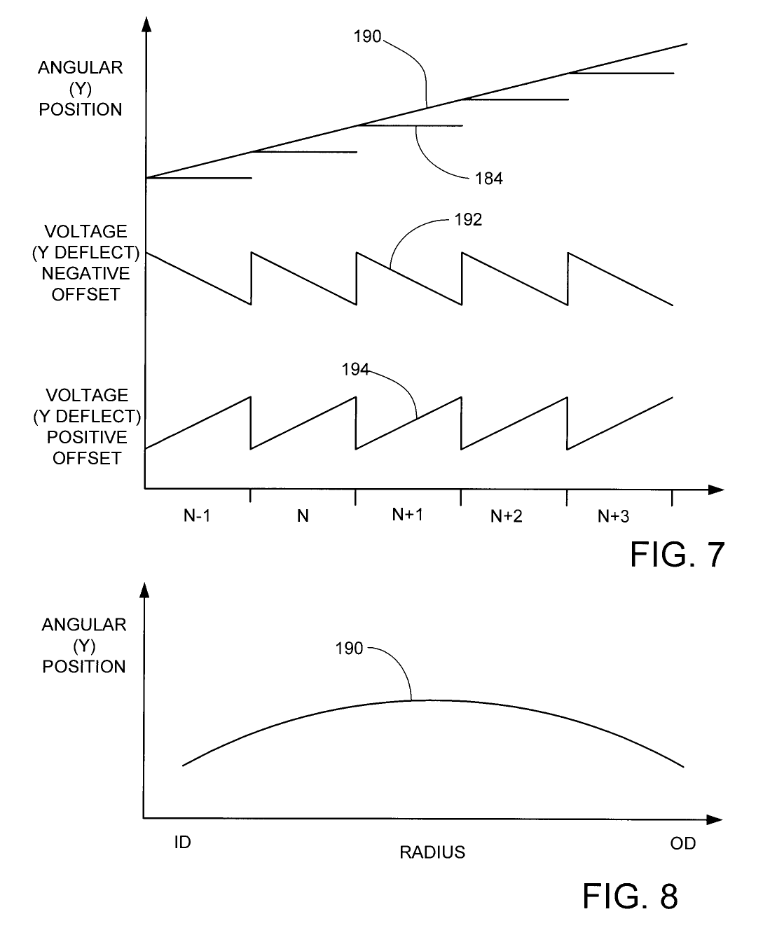

FIG. 7 shows a portion of a Y direction write head translation curve 190, generally representative of the movement of the head assembly 136 in the Y direction (i.e., with respect to angular orientation of the medium). While the curve 190 is shown to be substantially linear in FIG. 7, it will be appreciated that the overall Y deflection of the curve 190 will vary over the entire radius of the medium from ID to OD, as generally represented in FIG. 8. It will be appreciated that the curvilinearity of the overall curve 190 generally corresponds to the curvilinearity of the rotary translation path 112 in FIG. 1.

It is thus contemplated that at some portions along the curve 190, the first data bit for the next track to be written will be angularly advanced with respect to the last data bit on a current track, such as in the illustrative case of FIG. 6C. For other portions along the curve 190, the first data bit for the next track to be written will be angularly recessed with respect to the last data bit on a current track, such as in the illustrative case of FIG. 6D.

Exemplary saw-tooth shaped Y deflection voltage profiles are respectively represented in FIG. 7 at 192 and 194. The profile 192 represents an exemplary Y deflection for a negative offset as in the case of FIG. 6C, and the profile 194 provides an exemplary Y deflection for a positive offset as in the case of FIG. 6D. The profiles 192, 194 are contemplated as constituting exemplary types of Y deflection signals that can be passed along path 162 in FIG. 3 to the Y deflection plates. It will be appreciated that the magnitude and slope of the respective profiles 192, 194 will vary in relation to the angular offset of bit 0 from one track to the next. It is contemplated that some intermediary tracks may have substantially no angular offset between adjacent tracks, in which case no change in Y deflection may be provided. As in FIG. 5, the exemplary data patterns written to each track over each revolution are represented at 184 in FIG. 7.

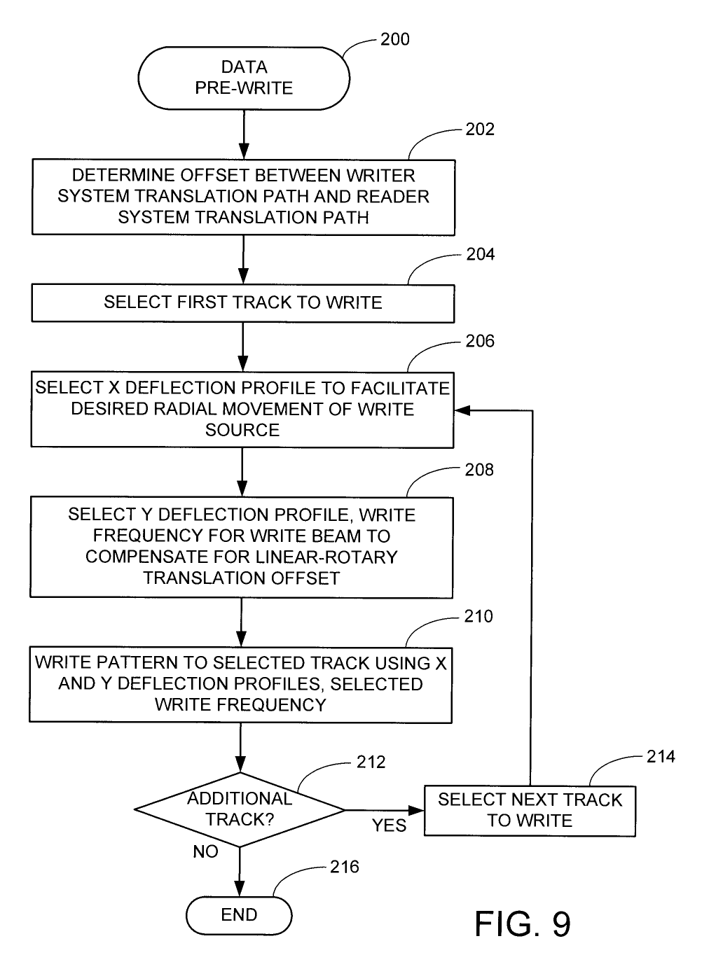

FIG. 9 provides a DATA PRE-WRITE routine 200 to summarize the foregoing discussion. The routine 200 represents steps carried out in accordance with various embodiments to pre-write data to a storage medium, such as the medium 102 using the writer system 130 of FIG. 2 (and EBR 150 of FIG. 3). As discussed above, it is contemplated that such pre-writing is provided to configure the medium for access by a reader system, such as the system 100 in FIG. 1.

At step 202, an initial determining step is carried out to characterize the geometric offset between the translation path of the writer system and the translation path of the reader system. This may include empirical analysis, mathematical modeling, or other appropriate steps. Generally, this step results in the identification of the necessary overall Y deflection trajectory that will be imparted to the write head assembly of the writer system (write source) across the radius of the medium, such as illustrated in FIG. 8.

The first track to which a pre-written pattern is to be written is next selected at step 204. This may be a first track at an innermost or outermost extent of the medium, although other starting tracks can be selected as desired.

At step 206, an appropriate X deflection profile is identified for the selected track to facilitate the desired radial movement of the write source across the medium in the X (radial) direction. As discussed above, one exemplary X deflection profile is set forth at 180 in FIG. 5, and constitutes a generally constant radial velocity that will be imparted to the write source. An appropriate X deflection signal, such as 182 in FIG. 5, is selected for the given track.

At step 208, an appropriate Y deflection profile and write frequency are identified for the selected track to facilitate the desired final location of the write source along the Y direction at the conclusion of the writing of the selected track. It will be recalled that the exemplary writer system 130 uses a linear actuator 134, which necessarily forces the write source to follow a linear path in space. That is, no Y direction deflection of the write source (head 136) is possible if such is contemplated as being with respect to a fixed reference, such as the central axis of the motor 132 (see FIG. 2).

What can be altered is the relative offset of the write source with respect to the medium. This is carried out by adjustably varying how much time is utilized to write each particular track.

By writing the data “slower” than would be normally warranted through the use of a reduced write frequency (as in FIG. 6C), the overall time required to write the data to the track will result in more than a full revolution of the medium by the time the entire track has been written. The continuous Y deflection of the write beam, however, will ensure that the last data bit is located at the desired endpoint of the track.

Thus, at the moment in time at which the last bit is written to the selected track, the medium will have rotated more than a full revolution, so the relative location of the write source (head 136) is advanced in the positive Y direction with respect to the medium, at the correct location to commence the writing of the first bit on the next track.

Contrawise, by writing the data “faster” than would be normally warranted through the use of an increased write frequency (as in FIG. 6D), the overall time required to write the data to the track will result in all of the data being written prior to the completion of a full revolution of the medium. As before, the application of a continuous positive offset to the write beam will result in the last data bit being located at the desired endpoint of the track. At this point, the write source will have the appropriate negative Y offset and be in place to commence the writing of the first data bit on the next track, even though this is recessed angularly with respect to the last data bit on the previous track.

Accordingly, step 208 involves the selection of the appropriate Y deflection signal and write frequency to both write the data as required to the track to “fill” the track, while at the same time placing the write source over the first bit for the next track. Without limitation, the Y deflection signal is exemplified by the saw-tooth profiles 192, 194 in FIG. 7, and applied via path 162 in FIG. 3 as explained above. In some embodiments, these various values are predetermined and stored in memory, so that steps 206 and 208 involve the retrieval of data from a lookup table or similar high speed memory structure. Alternatively, such values can be calculated on-the-fly.

Continuing with the flow of FIG. 9, the appropriate data pattern is written at step 210, such as via the data modulation signal on path 166 in FIG. 3, while applying the desired X and Y deflection profiles, such as via the paths 160, 162 in FIG. 3.

Decision step 212 queries whether any additional tracks need be written; if so, the routine passes to step 214 where the next track is selected for a pre-write operation, and the routine passes back to step 206. This continues until all of the tracks are written, after which the routine ends as shown at 216.

The routine of FIG. 9 provides adjustments in write frequency to compensate for the Y directional deflection of the write head assembly, thereby providing the individual bits with the appropriate bit length along each track. It will be appreciated, however, that such is not necessarily required. In alternative embodiments, the write frequency is maintained at a constant value and the rotational speed of the medium is changed (i.e., sped up or slowed down) to provide the bits with the desired bit lengths. In further embodiments, both adjustments in write frequency and changes in rotational velocity are effected to provide the desired bit lengths.

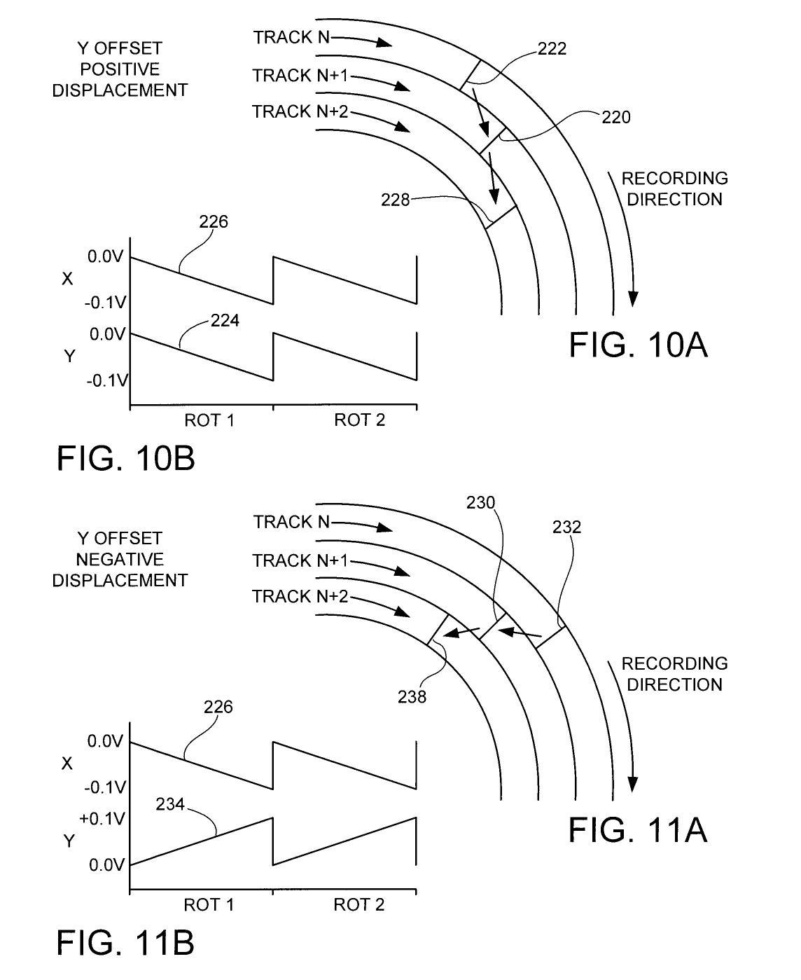

FIG. 10A illustrates the writing of successive tracks N, N+1 and N+2 to a medium in accordance with FIG. 9. A positive displacement of Y offset is used in FIG. 10A, so that the beginning/endpoint 220 of track N+1 is displaced in a positive angular direction as compared to the beginning/endpoint 222 of track N. By way of illustration, assume a total of 1 million (1,000,000) data bits are to be recorded to each track, and the medium is rotated at nominally 1 rotation/second. The nominal data channel rate will thus be 1 million hertz. Further assume that the angular displacement of endpoint 220 is exactly 1 bit beyond endpoint 222. Thus, the distance from the beginning of track N to the start of track N+1 will be exactly 1,000,001 data bits. The length of each data bit at track N will be assumed to be 1 micrometer, μm and the Y deflection function of the recording beam is 1 μm per volt (1 μm/V). Other values could be used, so the foregoing are merely exemplary.

Using the above values, the recording system could operate to fix the data clock rate of track N at 999,999 hz. This will cause the end of track N to occur 1 data bit later on the substrate than it should, which coincides where track N+1 should start. A Y axis deflection saw tooth signal 224 as shown in FIG. 10B is applied to the recording beam while track N is being recorded, so that there is no Y axis deflection applied at the beginning of track N and −1 μm of deflection at the end of the completion of the rotation for track N. Concurrently, an X axis deflection signal 226 is applied to maintain the write beam at the desired radius for track N.

The effect of the Y axis deflection signal 224 will be to “compress” the recorded data bits uniformly along track N, so that data bit 1,000,000 will end at exactly the desired angular position on track N. At the end of data bit 1,000,000 on track N, the Y axis deflection signal will return to 0V, which will result in the recording beam being returned to its non-deflected position at the angular start of track N+1. The process can then continue for subsequent tracks. Appropriate write frequency and Y axis deflection values can be selected to arrange the write beam to complete the writing of data bits to track N+1 and commence the writing of data bits at the beginning 228 of track N+2. The write frequencies and Y axis deflection for each track may vary depending on the beginning location of each track relative to the previous track. It is preferred that the write frequency and deflection values be selected to nominally return the write beam to a “zero point” for both X and Y deflection values at the beginning of each new track. This reduces the possibility of the cumulative deflection range exceeding the available deflection range of the writing beam. In some embodiments, a table of write frequency and Y axis deflection values is tabulated prior to the writing operation, so that the location of every bit on the medium is predetermined.

FIGS. 11A and 11B show corresponding writing operations upon tracks N, N+1 and N+2 with negative displacement in the Y offset direction. That is, the beginning 230 of track N+1 is in a negative angular direction with respect to the beginning 232 of track N. In this case, a higher write frequency may be applied during the writing of the 1 million data bits to track N, such as 1,000,001 hz. A positive Y axis displacement of from 0V to +0.1V is applied as shown by Y axis deflection signal 234. As before, this will place the write beam with substantially zero X and Y displacement over the beginning point 230 of track N+1. Similar frequency and Y displacement adjustments are applied during the writing of data to track N+1 so that the write beam is properly located over the beginning point 238 of track N+2.

It will be appreciated that various embodiments of the present invention can advantageously emulate substantially any final translation geometry for any reader system using substantially any translation geometry of writer system. While presently preferred embodiments have been disclosed herein, it will be appreciated that the present disclosure can be adapted for use in numerous applications in accordance with the following claims.

What is claimed is:

1. A method comprising:
rotating a data storage medium; and
using a write beam to write data to the rotating storage medium in the form of a plurality of concentric data tracks while continuously adjusting a deflection angle of the write beam in an axial direction along each track.

2. The method of claim 1, where the write beam is axially deflected during said writing to impart a desired angular offset between a beginning point of a first track and a beginning point of an immediately adjacent second track.

3. The method of claim 1, wherein the using step comprises writing data to a selected track by continuously changing a deflection angle of the write beam in a direction along the selected track from a first value at the beginning of the selected track to a second value at the end of the selected track.

4. The method of claim 1, wherein each track is written over a successive revolution of the storage medium, and wherein the deflection of the write beam adjusts an angular location of the beginning of each successive track compared to an angular location of each immediately previous track.

5. The method of claim 1, wherein the using step comprises radially advancing the write beam along a first translation path between an outermost diameter (OD) to an innermost diameter (ID) of the medium while writing each of the plurality of tracks in turn, said continuous deflection of the writing beam selected to align beginning points of each of the tracks to lie along a different, second translation path corresponding to a reader system configured to subsequently read the medium or a replica thereof.

6. The method of claim 5, wherein a selected one of the first or second translation paths is characterized as a linear translation path and a remaining one of the first or second translation paths is characterized as a rotary translation path.

7. The method of claim 5, wherein the first translation path is characterized as a rotary translation path with a first swing arm distance from pivot point to head assembly, and the second translation path is characterized as a rotary translation path with a different, second swing arm distance from pivot point to head assembly.

8. The method of claim 1, wherein said axial direction along each track is characterized as a Y axis so that Y axis deflection is continuously applied during the writing of each track, wherein a radial direction through a central axis about which the storage medium rotates is characterized as an X axis, and wherein the using step further comprises continuously advancing a portion of the write beam along the X axis while applying X axis deflection to a remaining portion of the write beam to maintain the beam over each track in turn.

9. The method of claim 8, wherein at the beginning of the writing of a selected track, the write beam commences writing data to said track with zero deflection along the X axis and zero deflection along the Y axis, wherein at the end of the writing of the selected track the write beam is at a maximum amount of X axis deflection and a maximum amount of Y axis deflection, and wherein said maximum amounts of X and Y deflection are concurrently removed to place the write beam at a desired location on the medium to begin writing the next immediately adjacent track with zero deflection along the X axis and zero deflection along the Y axis.

10. The method of claim 1, wherein the using step comprises rotating the medium at a constant angular velocity while writing a first track at a first write frequency and writing a second track at a different, second write frequency, wherein both tracks receive a common total number of channel bits written thereto and said axial deflection adjusts a total circumferential length of each of the first and second tracks.

11. An apparatus, comprising:
a data storage medium configured for rotation by a motor; and
a write system which applies a write beam to the rotating storage medium to write data in the form of a plurality of concentric data tracks while continuously adjusting a deflection angle of the write beam in an axial direction along each track.

12. The apparatus of claim 11, where the write system axially deflects the write beam during said writing to impart a desired angular offset between a beginning point of a first track and a beginning point of an immediately adjacent second track.

13. The apparatus of claim 11, wherein the write system writes said data to a selected track by continuously changing a deflection angle of the write beam in a direction along the selected track from a first value at the beginning of the selected track to a second value at the end of the selected track.

14. The apparatus of claim 11, wherein each track is written over a successive revolution of the storage medium, and wherein the deflection of the write beam adjusts an angular location of the beginning of each successive track compared to an angular location of each immediately previous track.

15. The apparatus of claim 11, wherein the write system operates by radially advancing the write beam along a first translation path between an outermost diameter (OD) to an innermost diameter (ID) of the medium while writing each of the plurality of tracks in turn, said continuous deflection of the writing beam selected to align beginning points of each of the tracks to lie along a different, second translation path corresponding to a reader system configured to subsequently read the medium or a replica thereof.

16. The apparatus of claim 15, wherein a selected one of the first or second translation paths is characterized as a linear translation path and a remaining one of the first or second translation paths is characterized as a rotary translation path.

17. The apparatus of claim 15, wherein the first translation path is characterized as a rotary translation path with a first swing arm distance from pivot point to head assembly, and the second translation path is characterized as a rotary translation path with a different, second swing arm distance from pivot point to head assembly.

18. The apparatus of claim 11, wherein said axial direction along each track is characterized as a Y axis so that Y axis deflection is continuously applied during the writing of each track, wherein a radial direction through a central axis about which the storage medium rotates is characterized as an X axis, and wherein the write system concurrently advances a portion of the write beam along the X axis while applying X axis deflection to a remaining portion of the write beam to maintain the beam over each track in turn.

19. The apparatus of claim 18, wherein at the beginning of the writing of a selected track, the write beam commences writing data to said track with zero deflection along the X axis and zero deflection along the Y axis, wherein at the end of the writing of the selected track the write beam is at a maximum amount of X axis deflection and a maximum amount of Y axis deflection, and wherein said maximum amounts of X and Y deflection are concurrently removed to place the write beam at a desired location on the medium to begin writing the next immediately adjacent track with zero deflection along the X axis and zero deflection along the Y axis.

20. The apparatus of claim 11, wherein the using step comprises rotating the medium at a constant angular velocity while writing a first track at a first write frequency and writing a second track at a different, second write frequency, wherein both tracks receive a common total number of channel bits written thereto and said axial deflection adjusts a total circumferential length of each of the first and second tracks.
